(19) United States
(12) Patent Application Publication
(10) Pub. No.: US 2019/0053590 A1
(43) Pub. Date: Feb. 21, 2019

(54) ELECTRONICS CASE WITH THERMOCHROMIC PANEL

(71) Applicant: CASE-MATE, INC., Atlanta, GA (US)

(72) Inventors: Nitin Koshy PHILIP, Sandy Springs, GA (US); Saumil Chetan MODY, Smyrna, GA (US)

(21) Appl. No.: 16/103,513

(22) Filed: Aug. 14, 2018

Related U.S. Application Data
(60) Provisional application No. 62/546,059, filed on Aug. 16, 2017.

(51) Int. Cl. A45C 11/00; C09K 9/00; C09D 11/50; G02F 1/01; H04B 1/3888

(52) U.S. Cl. CPC A45C 11/00; C09K 9/00; C09D 11/50; A45C 2011/003; H04B 1/3888; A45C 2011/002; G02F 1/0147

(57) ABSTRACT

A case for an electronic device according to an example embodiment of the invention. The case defines a space or housing for receiving an electronic device such as a smartphone or tablet computer. At least a portion of the case is formed from a thermochromatic material. As used herein, the term thermochromic refers to a material that changes color in response to a change in temperature of the material and/or a temperature of an object contacting the material.

### CROSS-REFERENCE TO RELATED APPLICATION

This application is related to U.S. Provisional Patent Application Ser. No. 62/546,059 filed Aug. 16, 2017, the entirety of which is hereby incorporated herein by reference for all purposes.

### TECHNICAL FIELD

The present invention relates generally to the field of protective and ornamental cases for handheld electronic devices, and more particularly to a case incorporating a temperature-responsive thermochromic panel.

### BACKGROUND

Cases are commonly utilized in connection with smartphones, tablet computers, and other electronic devices, to protect the electronic device from damage and/or for ornamentation and style. Continuing improvements in the field are sought. It is to the provision of cases for electronic devices meeting these and other needs that the present invention is primarily directed.

### SUMMARY

In example embodiments, the present invention provides a case for an electronic device according to an example embodiment of the invention. The case defines a space or housing for receiving an electronic device such as a smartphone or tablet computer. At least a portion of the case is formed from a thermochromatic material. As used herein, the term thermochromic refers to a material that changes color in response to a change in temperature of the material and/or a temperature of an object contacting the material.

In one aspect, the present invention relates to an electronic device case including a temperature-responsive thermochromic material configured to change color when contacted with an object exhibiting a temperature above room temperature.

In another aspect, the invention relates to an electronic device case including an inner shell comprising a resilient impact absorbing inner bumper, a protective hard outer shell, a soft padding layer on an exterior surface of the outer shell, and a temperature-responsive thermochromic panel applied over the padding layer.

These and other aspects, features and advantages of the invention will be understood with reference to the drawing figures and detailed description herein, and will be realized by means of the various elements and combinations particularly pointed out in the appended claims. It is to be understood that both the foregoing general description and the following brief description of the drawings and detailed description of example embodiments are explanatory of example embodiments of the invention, and are not restrictive of the invention, as claimed.

### BRIEF DESCRIPTION OF THE DRAWINGS

FIG. 1 is a perspective view of a case for an electronic device according to an example embodiment of the present invention.

FIG. 2 is an exploded view of the case of FIG. 1.

FIG. 3 is a detailed side cross-sectional view of the case of FIG. 1.

FIG. 4 is a perspective view of the case of FIG. 1, with a hand engaging the thermochromic panel.

FIG. 5 is a perspective view of the case of FIG. 1, showing the changes in color of the thermochromic panel.

FIG. 6 is a back view of a case for an electronic device according to another example embodiment of the invention.

### DETAILED DESCRIPTION OF EXAMPLE EMBODIMENTS

The present invention may be understood more readily by reference to the following detailed description of example embodiments taken in connection with the accompanying drawing figures, which form a part of this disclosure. It is to be understood that this invention is not limited to the specific devices, methods, conditions or parameters described and/or shown herein, and that the terminology used herein is for the purpose of describing particular embodiments by way of example only and is not intended to be limiting of the claimed invention. Any and all patents and other publications identified in this specification are incorporated by reference as though fully set forth herein.

Also, as used in the specification including the appended claims, the singular forms “a,” “an,” and “the” include the plural, and reference to a particular numerical value includes at least that particular value, unless the context clearly dictates otherwise. Ranges may be expressed herein as from “about” or “approximately” one particular value and/or to “about” or “approximately” another particular value. When such a range is expressed, another embodiment includes from the one particular value and/or to the other particular value. Similarly, when values are expressed as approximations, by use of the antecedent “about,” it will be understood that the particular value forms another embodiment.

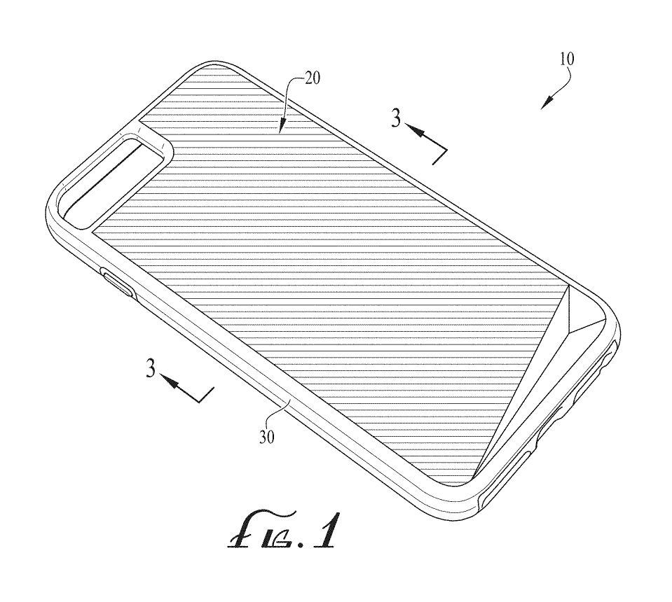

With reference now to the drawing figures, wherein like reference numbers represent corresponding parts throughout the several views, FIGS. 1-5 show a case 10 for an electronic device according to an example embodiment of the invention. The case 10 defines a space or housing for receiving an electronic device such as a smartphone, e-reader, or tablet computer. At least a portion of the case 10 is formed from a thermochromatic material. As used herein, the term thermochromic refers to a material that changes color in response to a change in temperature of the material and/or a temperature of an object contacting the material.

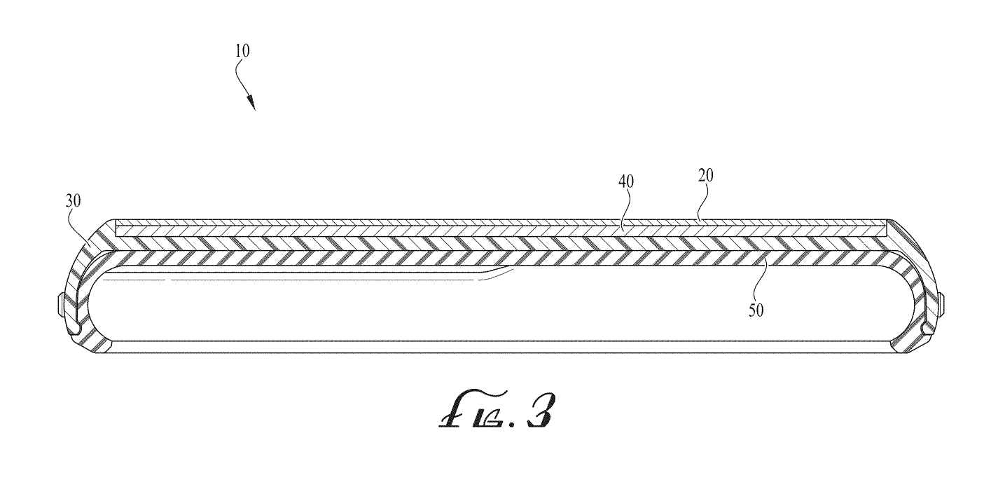

In example embodiments, the case 10 generally comprises a soft inner bumper 50, for example, formed from a flexible thermoplastic polyurethane (TPU), configured to be engaged within a hard outer shell 30 for example formed of polycarbonate (PC), as best seen in FIG. 3. U.S. Pat. No. 8,695,798 is hereby incorporated herein for reference and shows additional details of an outer shell and inner bumper configuration suited for adaptation in connection with example embodiments of the present invention. Various other case configurations may also be adapted for use in connection with example embodiments of the present invention.

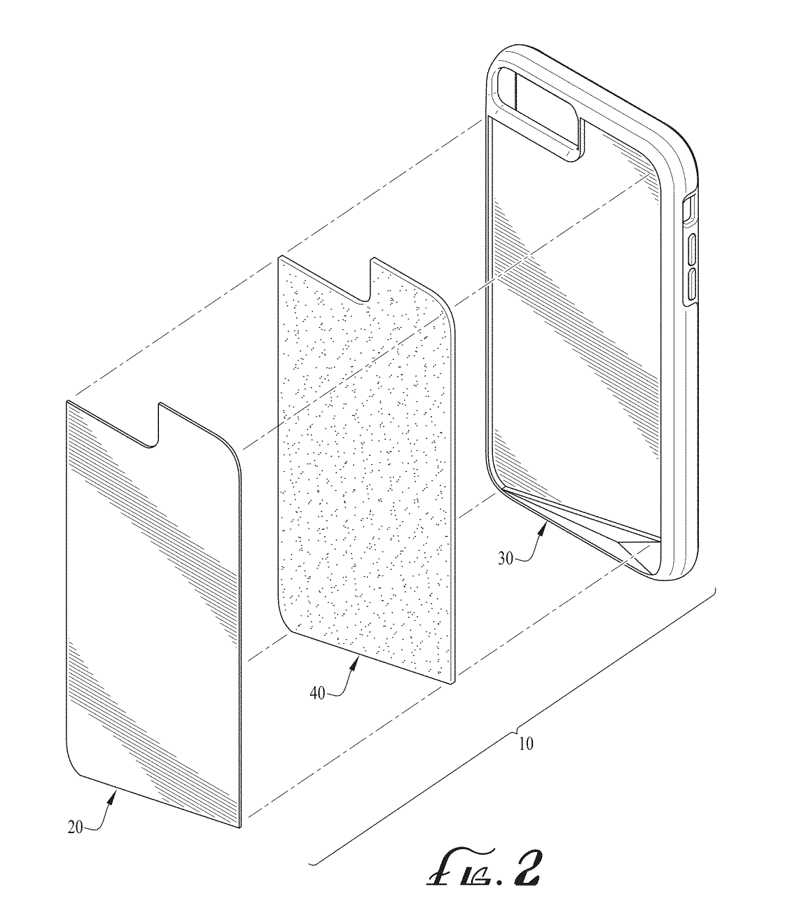

In example embodiments, the thermochromic material can be positioned on the back side of the hard outer shell 30. In example embodiments, the case 10 comprises a thermochromic panel 20 applied to the outer shell 30, for example along at least a portion of the back of the shell and in a position that is externally visible with an electronic device housed in the case, as best seen in FIGS. 1 and 2. In example embodiments, a soft, padding layer 40 is optionally provided between the outer shell 30 and a thermochromic panel 20, as shown in FIG. 2. In other embodiments, portions of the case 10, such as the inner bumper 50 or outer shell 30 can be formed, in whole or in part, from a thermochromic material. Optionally, the outer shell 30 and/or the inner bumper 50 may comprise one or more reflective, glossy, colored or otherwise aesthetically ornamented portions complementary to the appearance of the thermochromic panel 20.

In example embodiments, the thermochromic panel 20 comprises a thermochromic liquid crystal sheet or panel material. The thermochromic sheet 20 can be formed from a polyethylene terephthalate (PET) sheet, panel or film having one or more thermochromic ink, paint or pigment materials applied thereon, such as for example comprising microencapsulated thermochromic liquid crystals or leuco dyes. In example embodiments, the thermochromic panel 20 comprises one or more color-changing, temperature-responsive inks. The inks may be applied to a film or substrate, and provide for the varying colors displayed by the thermochromic panel 20. The thermochromic material can also be formed from polymers having an embedded thermochromic additive. In example embodiments, the thermochromic panel 20 may be die cut or otherwise manufactured, having a size and shape configured to correspond to a panel, recess, surface or other portion of the outer shell 30 to which the thermochromic panel is to be applied.

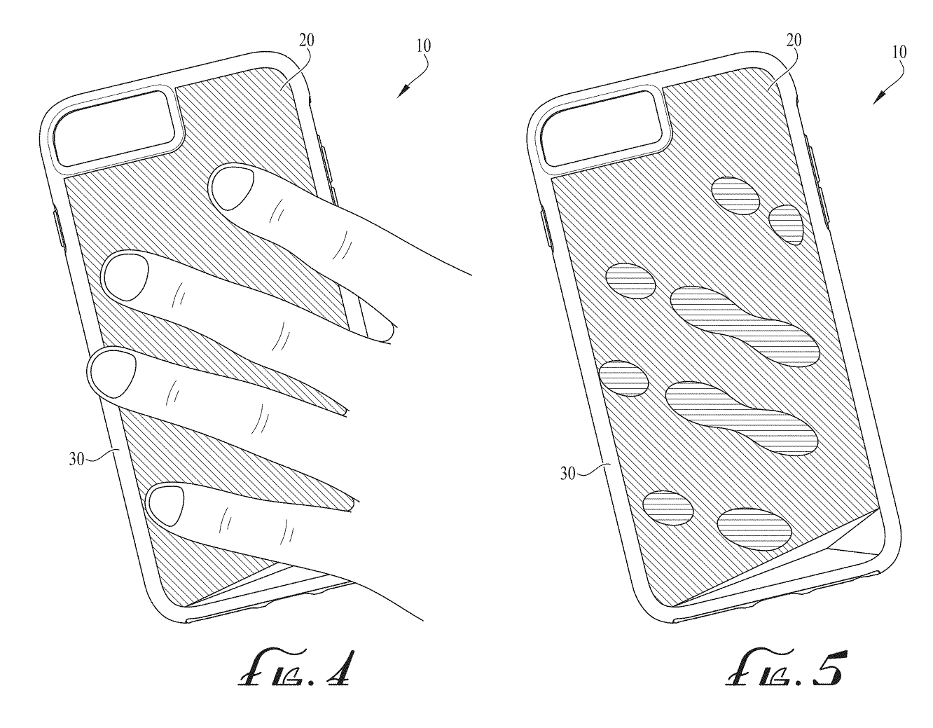

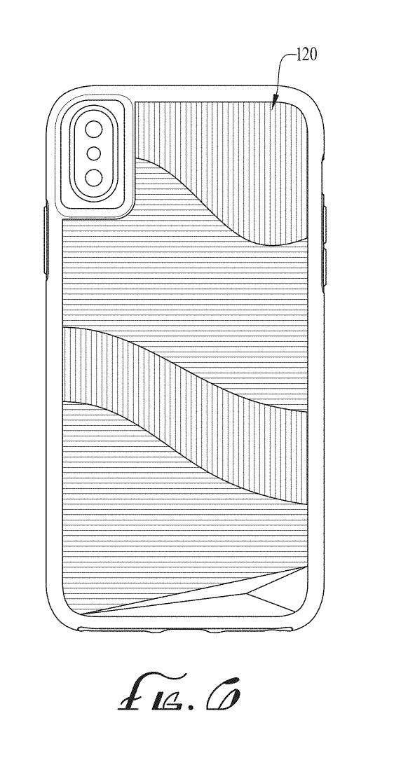

In example embodiments, the thermochromic panel 20 changes color when contacted by an object that has a higher or lower temperature than the thermochromic panel 20. In example embodiments, only areas of the thermochromic panel 20 directly contacted by the object and/or adjacent to the object change color, while other areas of the thermochromic panel 20 remain unaffected, as shown in FIGS. 4 and 5. In alternate embodiments, the thermochromic panel 20 changes color when the temperature of the surrounding air increases or decreases, even if no external object is present and in contact therewith. In example embodiments, removal of the object that has caused the thermochromic panel 20 to change color results in return of the thermochromic panel 20 to its original color. In some embodiments, the return to original color is instantaneous. In other embodiments, the return to original color may be delayed as the thermochromic panel 20 slowly cools.

In example embodiments, the thermochromic panel 20 passes through a series or range of different colors in response to different temperatures, for example where each temperature in the range corresponds to a slight variation in color. In example embodiments, the series of colors comprises colors in the visible spectrum including, for example, red, orange, yellow, green, blue, and violet.

In example embodiments, a temperature-sensitive ink mixture turns from colorless (e.g., black against a black background) or a base color to red at a given lower temperature and, as the temperature increases, passes through the range of other colors of the visible spectrum in sequence before turning colorless (e.g., black) again at a higher temperature. Further in example embodiments, upon heating, the thermochromic panel may first display a red color and proceed upon heating to display colors of the visible spectrum associated with decreasing wavelengths and increasing frequencies (e.g., red, orange, yellow, green, blue, violet) before turning colorless again at higher temperatures. In example embodiments, under ideal room temperature conditions, the thermochromic panel 20 can display color-changing properties over the range of about 74° F. to about 95° F. In this embodiment, the thermochromic panel 20 can appear black or colorless (or another base color) at or below 68° F. or at or above 108° F. In other embodiments, the thermochromic material can display color-changing properties over a different temperature range, including a larger or smaller temperature range.

In particular embodiments, the thermochromic panel 120 comprises three inks with slightly different but overlapping ranges of temperature responsiveness. Further in this embodiment, at any given temperature in the temperature range, the three inks can exhibit the same or different colors, as shown in FIG. 6. The inks can be superimposed in the same physical space and when temperature-activated, the colors exhibited by the inks blend together and appear as a single color and/or as a pattern comprising elements of multiple different colors. For example, the inks can blend to display a segment of a first color differing from the base color, with one or more fringes or rings of a second color (and optionally third, fourth and/or further colors) differing from the base color and the first color. In any of these embodiments, as the thermochromic panel 20 cools, the color change proceeds from warm to cool in reverse of the color order exhibited upon initial warming.

In other embodiments, the thermochromic properties of the panel result from a combination of inks that exhibit color-changing behavior over different, but overlapping, temperature ranges. For example, the thermochromic panel 20 can comprise a double-event or triple-event thermochromic sheet having two or three (or more) thermochromic inks of different color and/or temperature response characteristics applied thereon. This combination can produce a mix of colors at room temperature, with a non-black base color, for example, a blue or violet base color at room temperature.

In further embodiments, at their lowest active temperatures, the inks begin as colorless inks with a black background for a short temperature duration, followed by a transition to red and further progress through the colors of the visible spectrum in order of decreasing wavelength, ending at violet before becoming colorless again. In one embodiment, the first ink has a thermal range of from about 68° F. to about 97° F., the second ink has a thermal range of from about 74° F. to about 103° F., and the third ink has a thermal range of from about 80° F. to about 108° F. Thus, for example, at about 77° F., the first ink can be blue, the second ink can be green, and the third ink can be colorless, resulting in a bluish-green appearance for the thermochromic panel. In another aspect, at about 80° F., the third ink can begin to take on a red color, while the first and second inks appear blue, resulting in a reddish-violet appearance to the thermochromic panel. In still another aspect, at about 95° F., the first ink may appear violet, while the second and third inks appear blue, resulting in a blue-violet appearance to the thermochromic panel. In an alternative aspect, at about 69° F., the second and third inks appear colorless, while the first ink appears to be a reddish-orange color. In further embodiments, two or more thermochromic panels may be applied to the case, for example having different base colors and/or differing color-change/temperature responsiveness, to provide further varying color effects. The multiple thermochromic panels can be layered on top of one another to produce a mix of colors.

In additional embodiments, the case optionally further comprises a thermally conductive and generally transparent protective film over the thermochromic panel 20 that serves to protect the panel from scratches, dirt, and other factors that would be detrimental to the performance of the thermochromic panel 20.

In use, the user installs the case onto a mobile phone, tablet computer, or other handheld electronic device in typical fashion. Then as the user touches the case during use and handling of the electronic device, the thermochromic panel 20 will change colors due to body heat from the user and/or changes in ambient temperatures. In this manner, the external appearance of the case will present different patterns of two or more colors, shades or intensity over time.

While the invention has been described with reference to example embodiments, it will be understood by those skilled in the art that a variety of modifications, additions, and deletions are within the scope of the invention, as defined by the following claims.

What is claimed is:

1. A case for an electronic device, at least a portion of the case comprising a color-changing thermochromic material having an original color and being temperature responsive to change the color of at least a portion of the thermochromic panel to a color differing from the original color upon exposure to a change in temperature.

2. The electronic device case of claim 1, wherein the thermochromic material is temperature-responsive to change color in response to a user handling the case.

3. The electronic device case of claim 1, wherein a change in temperature of the thermochromic material occurs when the thermochromic material is contacted by an object having a temperature greater or lower than room temperature.

4. The electronic device case of claim 3, wherein the thermochromic material only changes color in areas directly contacted by the object having a temperature greater or lower than room temperature.

5. The electronic device case of claim 3, wherein the thermochromic material returns to its original color upon reversal of the change in temperature.

6. The electronic device case of claim 1, wherein the thermochromic material passes through a series of different colors in response to passing through a range of different temperatures.

7. The electronic device case of claim 6, wherein the series of different colors comprises colors in the spectrum of visible light.

8. The electronic device case of claim 6, wherein the series of different colors comprises red, orange, yellow, green, blue, and violet.

9. The electronic device case of claim 1, wherein the thermochromic material comprises one or more color-changing, temperature-responsive inks.

10. The electronic device case of claim 9, wherein the thermochromic material comprises three color-changing, temperature-responsive inks.

11. The electronic device case of claim 10, wherein the three inks exhibit different colors at the same temperature.

12. The electronic device case of claim 11, wherein the different colors exhibited by the three inks blend and appear as one color.

13. The electronic device case of claim 6, wherein the thermochromic material changes color over a temperature range of from about 68° F. to about 108° F.

14. An electronic device case comprising:
an inner bumper comprising thermoplastic polyurethane;
an outer shell comprising polycarbonate;
a soft padding layer; and
a temperature-responsive thermochromic panel.

15. The electronic device case of claim 14, wherein the thermochromic panel comprises thermochromic liquid crystals.

16. The electronic device case of claim 14, wherein the thermochromic panel comprises a leuco dye.

17. The electronic device case of claim 14, wherein the thermochromic panel comprises a thermochromic ink.

18. The electronic device case of claim 14, further comprising a second thermochromic panel having a different base color than the first thermochromic panel.

19. The electronic device case of claim 14, further comprising a protective film situated over the thermochromic panel.

20. The electronic device case of claim 19, wherein the protective film is thermally conductive.
